(19) United States
(12) Patent Application Publication
(10) Pub. No.: US 2015/0277103 A1
(43) Pub. Date: Oct. 1, 2015

(54) MICROELECTROMECHANICAL DISPLACEMENT STRUCTURE AND METHOD FOR CONTROLLING DISPLACEMENT

(71) Applicants: Luzhong Yin, Andover, MA (US); Jing Zhao, Winchester, MA (US)

(72) Inventors: Luzhong Yin, Andover, MA (US); Jing Zhao, Winchester, MA (US)

(21) Appl. No.: 14/242,328

(22) Filed: Apr. 1, 2014

(51) Int. Cl. G02B 26/02

(52) U.S. Cl. CPC G02B 26/02

(57) ABSTRACT

The present disclosure provides a displacement amplification structure and a method for controlling displacement. In one aspect, the displacement amplification structure of the present disclosure includes a first beam and a second beam substantially parallel to the first beam, an end of the first beam coupled to a fixture site, and an end of the second beam coupled to a motion actuator; and a motion shutter coupled to an opposing end of the first and second beams. In response to a displacement of the motion actuator along an axis direction of the second beam, the motion shutter displaces a distance along a transversal direction substantially perpendicular to the axis direction.

### TECHNICAL FIELD

The present disclosure relates to a microelectromechanical systems (MEMS) displacement structure and a method for controlling displacement. More particularly, the present disclosure relates to a MEMS displacement structure that can generate a large displacement by a small actuation motion and a method for controlling displacement.

### BACKGROUND

MEMS structures that are capable to generate a large displacement have wide uses in various applications, such as optical shutter for laser, variable optical actuator for fiber, optical switch, etc. However, MEMS devices are intrinsically small in size. Therefore, efficient mechanical motion amplification structure is critical for many commercial applications.

Several MEMS displacement amplification designs have been reported. These designs, however, have deficiencies for practical use. In one case, an electrostatic actuator with amplifier can only generate a displacement of less than 200 microns. In order to reach such displacement, a very high voltage is required to generate the necessary force for this type of structure. In another case, a thermal actuator amplifier can be driven at a low voltage. However, traditional thermal actuators can only generate a displacement of around 10-12 microns.

The market needs a MEMS structure that can generate a displacement of more than 500 microns within a small chip footprint. Accordingly, there is a need to develop a new MEMS structure that can generate a displacement of more than 500 microns within a small chip footprint and that can be produced at very low cost.

### SUMMARY

A MEMS structure that can generate a large displacement, more than 500 microns, in one instance, within a small chip footprint are disclosed herein below.

In one aspect, the present disclosure provides a displacement amplification structure. The displacement amplification structure comprises a first beam and a second beam substantially parallel to the first beam, an end of the first beam coupled to a fixture site, and an end of the second beam coupled to a motion actuator; and a motion shutter coupled to an opposing end of the first and second beams; wherein, in response to a displacement of the motion actuator along an axis direction of the second beam, the motion shutter displaces along a transversal direction substantially perpendicular to the axis direction. The displacement of the motion actuator may be caused, for example, but not limited to, by one of thermal expansion, motion driven by piezoelectricity, motion driven by magnetic force, and motion driven by electrostatic force. The motion shutter may have, for example, but not limited to, a shape selected from one of a square, a rectangle, a circle, an oval, and a polygon.

In one embodiment, the displacement of the motion actuator along the axis direction ranges from about 25 to about 50 microns, and the motion shutter displaces a distance along the transversal direction for about 500 to 1,000 microns.

In one embodiment, the first and second beams have a strip shape and comprise an elastic material.

According to another aspect, the present disclosure provides a MEMS device. The MEMS device comprises a frame including a fixture site, the frame defining an actuating region and a response region; first and second electrodes in the actuating region and mechanically coupled to the frame; a motion actuator in the actuating region and electrically coupled to the first and second electrodes; first and second beams in the response region, the second beam being substantially parallel to the first beam, wherein an end of the first beam is coupled to the fixture site, and an end of the second beam is coupled to the motion actuator; and a motion shutter in the response region and mechanically coupled to an opposing end of the first and second beams.

In one embodiment, the motion actuator is configured to cause a displacement of the second beam along an axis direction of the second beam in response to a voltage applied to the motion actuator through the first and second electrodes.

In one embodiment, the motion actuator is configured to have an angled shape having a vertex portion and an interior angle ranging from about 120 degrees to about 180 degrees.

In one embodiment, the motion actuator comprises an electrothermal material used to create a thermomechanical action.

In one embodiment, the motion shutter displaces a distance along a transversal direction substantially perpendicular to the axis direction, in response to the displacement of the motion actuator.

In one embodiment, the second beam is mechanically coupled to the vertex portion of the motion actuator.

According to one aspect, the present disclosure provides a method for controlling a motion shutter. The method comprises providing a MEMS device comprising a frame including a fixture site, the frame defining an actuating region and a response region, first and second electrodes in the actuating region and mechanically coupled to the frame, a motion actuator in the actuating region and electrically coupled to the first and second electrodes, first and second beams in the response region, the second beam being substantially parallel to the first beam, wherein an end of the first beam is coupled to the fixture site, and an end of the second beam is coupled to the motion actuator, a motion shutter in the response region and mechanically coupled to an opposing end of the first and second beams; and applying a voltage to the first and second electrodes to cause a displacement of the motion actuator along the axis direction; wherein, in response to the displacement of the motion actuator, the motion shutter displaces a distance along a transversal direction substantially perpendicular to the axis direction.

### BRIEF DESCRIPTION OF THE DRAWINGS

The present disclosure is to be read in conjunction with the accompanying drawings, in which:

FIG. 1 illustrates a MEMS displacement amplification structure, in accordance with one embodiment of the present disclosure;

FIGS. 2A and 2B respectively illustrate a plain view and a perspective view of a MEMS displacement amplification structure, in accordance with one embodiment of the present disclosure; and

FIG, 3 illustrates a simulation result of a MEMS displacement amplification structure, in accordance with one embodiment of the present disclosure.

### DETAILED DESCRIPTION

The following detailed description is of the best currently contemplated modes of carrying out the present disclosure. The description is not to be taken in a limiting sense, but is made merely for the purpose of illustrating the general principles of the present disclosure, because the scope of the present disclosure is defined by the appended claims.

As used herein, the singular forms “a” “an,” and “the” include the plural reference unless the context clearly dictates otherwise.

Except where otherwise indicated, all numbers expressing quantities of ingredients, reaction conditions, and so forth used in the specification and the claims are to be understood as being modified in all instances by the term “about.” Further, any quantity modified by the term “about” or the like should be understood as encompassing a range of ±10% of that quantity.

For the purposes of describing and defining the present disclosure, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

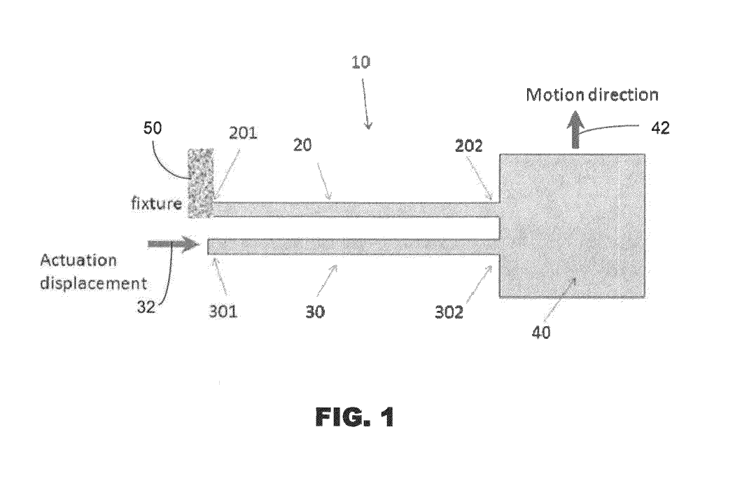

FIG. 1 illustrates a MEMS displacement amplification structure, in accordance with one embodiment of the present disclosure. As shown in FIG. 1, an displacement amplification structure 10 includes first and second beams 20 and 30 that are closely posed and substantially parallel to each other, In one embodiment, first and second beams 20 and 30 have a stripe shape, and comprise an elastic or flexible material, such as silicon. In one embodiment, first and second beams 20 and 30 are separated with each other by a gap of about 20 to 75 microns.

As shown in FIG. 1, end 201 of first beam 20 is fixed to an immobilized fixture 50. End 301 of second beam 30 has a degree of freedom along an axis direction 32 of second beam 30. Ends 202 and 302 of beams 20 and 30 are connected to a motion shutter 40. In this particular embodiment, motion shutter 40 has a square shape. It is appreciated that motion shutter 40 may of other shapes, such as, but not limited to, rectangle, triangle, circle, oval, polygon, etc. In one embodiment, motion shutter 40 is made of an opaque material, such as silicon coated with gold.

A small input displacement (e.g., 25 to 50 microns) along axis direction 32 of second beam 30 at end 301 bends first and second beams 20 and 30, and causes a differential axis motion between first and second beams 20 and 30. The differential motion transfers into a large displacement (e.g., 500 to 1,000 microns) for motion shutter 40 in a transversal direction 42. The input displacement can be generated by thermal expansion, magnetic force, electrostatic force, piezoelectricity, and other suitable actuation sources.

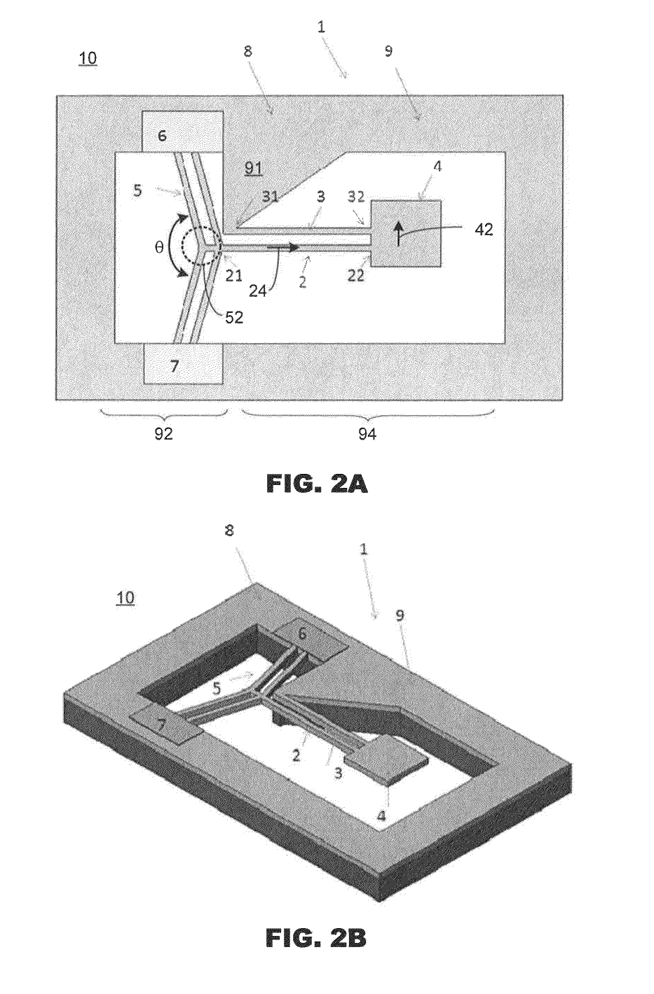

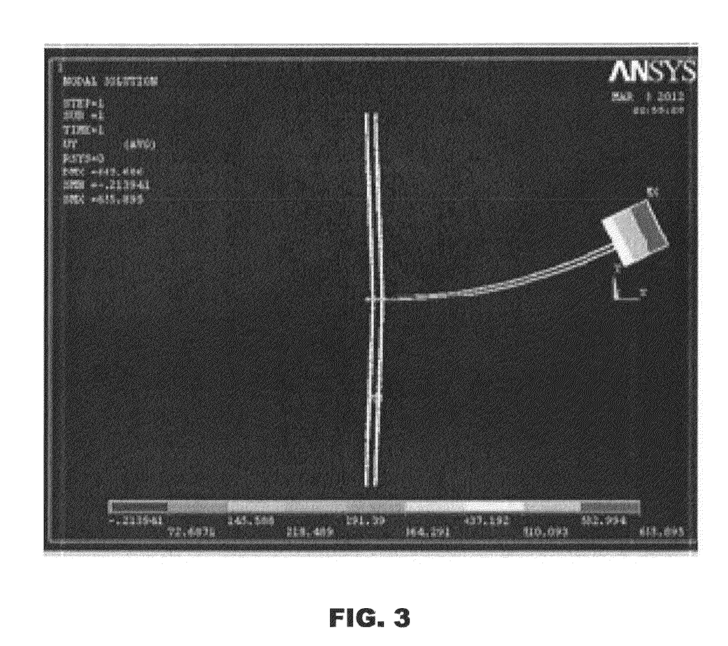

FIGS. 2A and 2B respectively illustrate a plain view and a perspective view of a MEMS displacement amplification structure, in accordance with one embodiment of the present disclosure. As shown in FIGS. 2A and 2B, a MEMS large motion structure 10 includes a frame 9 defining a planar surface 8, first and second beams 2 and 3, a motion shutter 4, a motion actuator 5, and first and second electrodes 6 and 7. In one embodiment, all of these components are configured in the same planar surface 8.

Frame 9 includes a fixture site 91 and further defines an actuating region 92 and a response region 94. First and second electrodes 6 and 7 are disposed in actuating region 92 and are mechanically coupled to frame 9. Motion actuator 5 is disposed in actuating region 92 and is electrically coupled to first and second electrodes 6 and 7.

First and second beams 2 and 3 are disposed in response region 94. Second beam 3 is substantially parallel to first beam 2. End 21 of first beam 2 is connected to a central portion (or output portion) of the actuator 5. End 22 of first beam 2 is connected to motion shutter 4. End 31 of second beam 3 is coupled to and immobilized at fixture site 91. End 32 of second beam 3 is mechanically coupled to motion actuator 4. Motion shutter 4 is disposed in the response region and mechanically coupled to ends 22 and 32 of first and second beams 2 and 3.

In one embodiment, an electric current or voltage (e.g., 3 Volts) is applied to motion actuator 5 through first and second electrodes 6 and 7, so as to cause a displacement (e.g., 500 microns) of second beam 2 along an axis direction 24 of second beam 2. In response to the displacement of motion actuator 5, motion shutter 4 displaces a distance along a transversal direction 42 substantially perpendicular to axis direction 24. In one embodiment, motion actuator 5 comprises an electrothermal material.

In one embodiment, motion actuator 5 has a V-shape or an angled shape, which has a vertex portion 52 and an interior angle θ ranging from about 120 degrees to about 180 degrees. In some embodiments, motion actuator 5 may have other shapes and may include a plurality of V-beams. In one embodiment, end 21 of second beam 2 is mechanically coupled to vertex portion 52 of motion actuator 5.

When an electric current/voltage is applied to motion actuator 5, a deformation along axis direction 24 is applied to first beam 2. Such deformation generates a differential motion along axis directions between first and second beams 2 and 3. Due to the constraint along axis direction, this differential axis motion leads to a very large transversal motion of first and second beams 2 and 3. As a result, motion shutter 5 also has a very large transversal motion. In certain embodiments, the transversal motion of motion shutter 5 can be more than 500-1,000 microns within a compact chip size of less than 4 mm. In one embodiment, MEMS structure 10 can be formed from a silicon-on-insulator (SOI) silicon wafer.

FIG. 3 illustrates a simulation result of a MEMS displacement amplification structure, in accordance with one embodiment of the present disclosure.

In summary, the microelectromechanical motion structure of the present disclosure generates a controlled transversal motion in response to a small deformation in an axis direction of a motion actuator comprising an electrothermal material. Axis motion of one beam causes a differential axis motion of two parallel neighboring beams. Those two beams, on one end, are connected with a motion shutter. The other end of one beam is connected to a V-beam thermal actuator, while the other end of the other beam is fixed at the substrate.

Although the present disclosure has been described with respect to various embodiments, it should be understood that these teachings are also capable of a wide variety of further and other embodiments within the spirit and scope of the appended claims.

What is claimed is:

1. A displacement amplification structure, comprising:
a first beam and a second beam substantially parallel to the first beam, an end of the first beam coupled to a fixture site, and an end of the second beam coupled to a motion actuator; and
a motion shutter coupled to an opposing end of the first and second beams;
wherein, in response to a displacement of the motion actuator along an axis direction of the second beam, the motion shutter displaces along a transversal direction substantially perpendicular to the axis direction.

2. The structure of claim 1, wherein the displacement of the motion actuator is caused by one of thermal expansion, motion driven by piezoelectricity, motion driven by magnetic force, and motion driven by electrostatic force.

3. The structure of claim 1, wherein the displacement of the motion actuator along the axis direction ranges from about 25 to about 50 microns, and the motion shutter displaces a distance along the transversal direction for about 500 to 1,000 microns.

4. The structure of claim 1, wherein the first and second beams have a strip shape and comprise an elastic material.

5. The structure of claim 1, wherein the motion shutter has a shape selected from one of a square, a rectangle, a circle, an oval, and a polygon.

6. A MEMS device comprising:
a frame including a fixture site, the frame defining an actuating region and a response region;
first and second electrodes in the actuating region and mechanically coupled to the frame;
a motion actuator in the actuating region and electrically coupled to the first and second electrodes;
first and second beams in the response region, the second beam being substantially parallel to the first beam, wherein an end of the first beam is coupled to the fixture site, and an end of the second beam is coupled to the motion actuator; and
a motion shutter in the response region and mechanically coupled to an opposing end of the first and second beams.

7. The device of claim 6, wherein the motion actuator is configured to cause a displacement of the second beam along an axis direction of the second beam in response to a voltage applied to the motion actuator through the first and second electrodes.

8. The device of claim 7, wherein, in response to the displacement of the motion actuator, the motion shutter displaces a distance along a transversal direction substantially perpendicular to the axis direction.

9. The device of claim 6, wherein the motion actuator comprises an electrothermal material.

10. The device of claim 6, wherein the motion actuator is configured to have an angled shape having a vertex portion and an interior angle ranging from about 120 degrees to about 180 degrees.

11. The device of claim 10, wherein the second beam is mechanically coupled to the vertex portion of the motion actuator.

12. A method for controlling a motion shutter, the method comprising:
providing a MEMS device comprising:
a frame including a fixture site, the frame defining an actuating region and a response region;
first and second electrodes in the actuating region and mechanically coupled to the frame;
a motion actuator n the actuating region and electrically coupled to the first and second electrodes;
first and second beams in the response region, the second beam being substantially parallel to the first beam, wherein an end of the first beam is coupled to the fixture site, and an end of the second beam is coupled to the motion actuator;
a motion shutter in the response region and mechanically coupled to an opposing end of the first and second beams; and
applying a voltage to the first and second electrodes to cause a displacement of the motion actuator along an axis direction;
wherein, in response to the displacement of the motion actuator, the motion shutter displaces a distance along a transversal direction substantially perpendicular to the axis direction.
